(19) United States
(12) Patent Application Publication
(10) Pub. No.: US 2026/0309169 A1
(43) Pub. Date: Oct. 8, 2026

(54) Hydraulic System

(71) Applicant: Caterpillar SARL, Geneva (CH)

(72) Inventors: Jared Wesley Brown, Canton, IL (US); Atsunori Shimamoto, Akashi-shi, Hyogo-ken (JP); Kensuke Tanaka, Akashi-shi, Hyogo-ken (JP); Matthew James Beschorner, Plainfield, IL (US); Vinod T. Yadav, Peoria, IL (US)

(21) Appl. No.: 19/483,301

(22) PCT Filed: May 21, 2024
(86) PCT No.: PCT/EP2024/025170

§ 371 Date: Nov. 11, 2025

(30) Foreign Application Priority Data
May 26, 2023 (GB) 2307900.7

(51) Int. Cl. F15B 15/20; E02F 9/22; F15B 1/26; F15B 13/02; F15B 13/04

(52) U.S. Cl. CPC F15B 15/20; E02F 9/2203; F15B 1/26; F15B 13/024; F15B 13/0401; E02F 9/2285; E02F 9/2292

(57) ABSTRACT

A controller configured to control hydraulic system for a work tool is provided. The controller is configured to cause an actuator of the hydraulic system to move from a first position to a second position in which the controller causes a first directional control valve and a second directional control valve of the hydraulic system to open such that hydraulic fluid is pumped from a hydraulic fluid pump to the actuator to cause the actuator to move to the second position, and the controller causes a relief valve of the hydraulic system to be closed such that hydraulic fluid does not flow through the relief valve. The controller is also configured to cause the actuator to move from the second position to the first position in which the controller causes the first and second directional control valves to open such that hydraulic fluid is pumped from the hydraulic fluid pump to the actuator to cause the actuator to move to the first position, and the controller causes the relief valve to open to allow hydraulic fluid to return from the actuator to a hydraulic fluid reservoir.

### FIELD OF THE DISCLOSURE

The present disclosure relates to a hydraulic system. In particular, the present disclosure relates to a hydraulic system for a work machine.

### BACKGROUND

Work machines may be utilised to operate on or more work tools. Work tools may be operated by means of one or more actuators, for example a hydraulic actuator.

Hydraulic actuators are device which provide mechanical motion in response to the flow of a hydraulic fluid into/out of the hydraulic actuator. A hydraulic fluid pump may be provided in order to pump hydraulic fluid into and out of the hydraulic actuator.

Against this background, an object of the present disclosure is to provide an improved, or at least commercially useful alternative controller for a hydraulic system, a hydraulic system, and a method for controlling a hydraulic system.

### SUMMARY

According to a first aspect of the disclosure, a controller configured to control hydraulic system for a work tool is provided. The controller is configured to cause an actuator of the hydraulic system to move from a first position to a second position in which:
the controller causes a first directional control valve and a second directional control valve of the hydraulic system to open such that hydraulic fluid is pumped from a hydraulic fluid pump to the actuator to cause the actuator to move to the second position, and
the controller causes a relief valve of the hydraulic system to be closed such that hydraulic fluid does not flow through the relief valve; and the controller is configured to cause the actuator to move from the second position to the first position in which:
the controller causes the first and second directional control valves to open such that hydraulic fluid is pumped from the hydraulic fluid pump to the actuator to cause the actuator to move to the first position; and
the controller causes the relief valve to open to allow hydraulic fluid to return from the actuator to a hydraulic fluid reservoir.

According to a first aspect of the disclosure, a controller for a hydraulic system is provided. The controller may be configured to control an actuator for a work tool in order to operate the work tool. In some embodiments, the work tool may be a shear (i.e. a hydraulic shear). The actuator may cause the e.g. shear to move from a first position (e.g. an open position) to a second position (e.g. a closed position) and vice versa. Advantageously, the controller may cause the hydraulic system to open an additional valve when moving the actuator from the second position (closed position) to the first position (open position) to allow hydraulic fluid to return to the hydraulic fluid reservoir. Such a configuration allows a relatively high flow rate of hydraulic fluid to be provided on the return path of the hydraulic system when moving from the second position (closed position) to the first position (open position). As such, the work tool may be able to move from the second position to the first position at a relatively faster rate. Thus, the work tool may return to the first position at a faster rate, thereby reducing the duration of the operating cycle of the work tool.

Embodiments of this disclosure may be particularly applicable to work tools having actuators with relatively large cylinder volumes. For example, in some embodiments, the actuator may have a cylinder volume of at least: 60 litres, 80 litres, 100 litres, 120 litres, or 140 litres. Where an actuator has a relatively large cylinder volume, attempting to move a relatively large volume of hydraulic fluid in a short duration of time can create a significant back pressure in the hydraulic system. The back pressure may effectively delay the movement of the actuator, thereby increasing the cycle time for the actuator. It will also be appreciated that the back pressure caused by the flow of hydraulic fluid causes the hydraulic pump to work harder than would otherwise be required. By opening an additional flow path for hydraulic fluid, the controller of the first aspect effectively reduces the back pressure in the hydraulic system, thereby allowing the actuator to return to the first position more quickly and with lower power consumption. Thus, the controller of the first aspect may improve an operating cycle of the work tool and may also improve a fuel efficiency associated with the work tool.

In some embodiments, the work tool to be controlled may be a shear, or other work tool where the majority of the mechanical work performed by the work tool over the operating cycle is due to the actuator moving from the first position to the second position. As such, when moving from the second position to the first position, very little, if any, effective work is performed by the work tool. Thus, in some embodiments, the flow rate of hydraulic fluid through the hydraulic system may limit the rate at which the work tool can return to the first position for a new operating cycle. According to the first aspect, the controller may cause the hydraulic system to effectively increase the flow rate of hydraulic fluid on the return path to allow the actuator to return to the first position relatively quickly.

Importantly, the relief valve may be closed during the main working operation of the hydraulic system (first position moving to second position), as it is not desirable to have allow a high flow rate on the return path while the actuator is performing mechanical work.

According to a second aspect of the disclosure, a hydraulic system for a work tool is provided. The hydraulic system comprises an actuator for the work tool, a first directional control valve configured to control the flow of hydraulic fluid to and from the actuator, a second directional control valve configured to the flow of hydraulic fluid to and from the actuator, a hydraulic pump configured to pump hydraulic fluid to the actuator via the first and second directional control valves, a hydraulic fluid reservoir connected to the first and second directional control valves and configured to receive hydraulic fluid flowing from the actuator via the first and second directional control valves, a relief valve configured to control the flow of hydraulic fluid from the actuator to the hydraulic fluid reservoir, the relief valve connected to the hydraulic fluid reservoir and configured to receive hydraulic fluid from the work tool, and the controller of the first aspect of the disclosure.

According to a third aspect of the disclosure a method of controlling a hydraulic system for a work tool is provided. The method comprises:
causing an actuator of the work tool to move from a first position to a second position in which:
a first directional control valve and a second directional control valve of the hydraulic system to open such that hydraulic fluid is pumped from a hydraulic fluid pump to the actuator to cause the actuator to move to the second position, and
a relief valve of the hydraulic system to be closed such that hydraulic fluid does not flow through the relief valve; and
causing the actuator to move from the second position to the first position in which:
the first and second directional control valves open such that hydraulic fluid is pumped to the actuator to cause the actuator to move to the first position; and
the relief valve opens to allow hydraulic fluid to return from the actuator to a hydraulic fluid reservoir.

It will be appreciated that the second and third aspects may incorporate any optional features and associated advantages of the first aspect of the disclosure. In particular, the controller of the first aspect, and/or the hydraulic system of the second aspect may be used to perform the method of the third aspect.

### BRIEF DESCRIPTION OF THE FIGURES

Embodiments of the disclosure will now be described with reference to the following non-limiting figures in which:

FIG. 1 is a schematic diagram of a hydraulic system according to an embodiment of the disclosure;

FIG. 2 is a schematic diagram of the hydraulic system of FIG. 1 when moving from the first position to the second position;

FIG. 3 is a schematic diagram of a hydraulic system of FIG. 1 when moving from the second position to the first position;

FIG. 4 is a graph showing the variation in hydraulic area of some valves of the hydraulic system in response to a lever command to move the actuator from a second position to a first position;

FIG. 5 is a schematic diagram of a hydraulic system of a further embodiment of the disclosure, when moving from the first position to the second position;

FIG. 6 is a schematic diagram of a hydraulic system of a further embodiment of the disclosure when moving from the second position to the first position;

FIG. 7 is a graph showing variation in hydraulic area of some valves of the hydraulic system in response to a lever command to move the actuator from a second position to a first position;

FIG. 8 is a schematic diagram of a hydraulic system according to another embodiment of the disclosure, wherein the actuator is moving from the first position to the second position;

FIG. 9 is a schematic diagram of a hydraulic system according to another embodiment of the disclosure, wherein the actuator is moving from the second position to the first position;

FIG. 10 is a block diagram of the controller and hydraulic system according to an embodiment of the disclosure; and

FIG. 11 is a block diagram of a method according to an embodiment of the disclosure.

### DETAILED DESCRIPTION

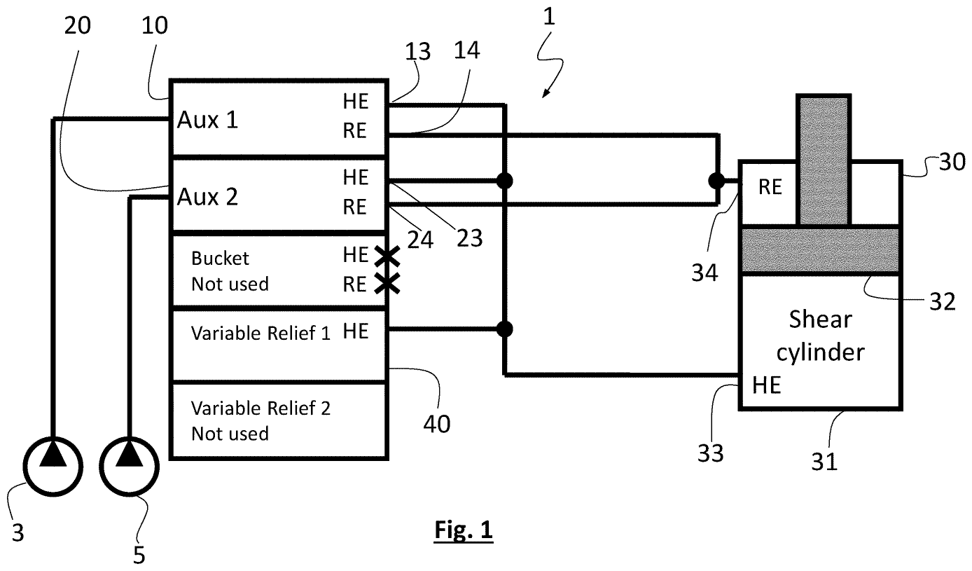

According to an embodiment of the disclosure, a hydraulic system 1 is provided. A schematic diagram of the hydraulic system 1 is shown in FIG. 1. As shown in FIG. 1, the hydraulic system 1 comprises a first hydraulic fluid pump 3, a second hydraulic fluid pump 5, a first directional control valve 10, a second directional control valve 20 an actuator 30, a relief valve 40 and a hydraulic reservoir 50.

The first hydraulic fluid pump 3 may be configured to pump hydraulic fluid from a hydraulic fluid reservoir (not shown in FIG. 1) though the hydraulic system 1. In the embodiment of FIG. 1, the first hydraulic fluid pump 3 is configured to pump hydraulic fluid to the first directional control valve 10 (Aux 1). In other embodiments, the first hydraulic fluid pump 3 may be configured to pump hydraulic fluid to a plurality of valves and/or actuators 30. The first hydraulic fluid pump 3 may be any pump suitable for pumping hydraulic fluid.

In some embodiments, the hydraulic system 1 may comprise a plurality of hydraulic fluid pumps. For example, in the embodiment of FIG. 1 a second hydraulic fluid pump 5 is provided. The second hydraulic fluid pump 5 may be provided in a similar manner to the first hydraulic fluid pump 5. In the embodiment of FIG. 1, the second hydraulic fluid pump 5 is configured to pump hydraulic fluid to the second directional control valve 20 (Aux 2). By providing two hydraulic fluid pumps 3, 5, the hydraulic system may pump a relatively high flow rate of hydraulic fluid to the actuator 30.

The first directional control valve 10 is configured to configured to control the flow of hydraulic fluid to and from the actuator 30. As such, the first directional control valve may be configured to allow hydraulic fluid to flow to actuator 30, and also to return from actuator 30, or the first directional control valve 10 may be configured to block the flow of hydraulic fluid to/from the actuator 30. In the embodiment of FIG. 1, the first directional control valve 10 may be a 4 port, 3 position directional control valve.

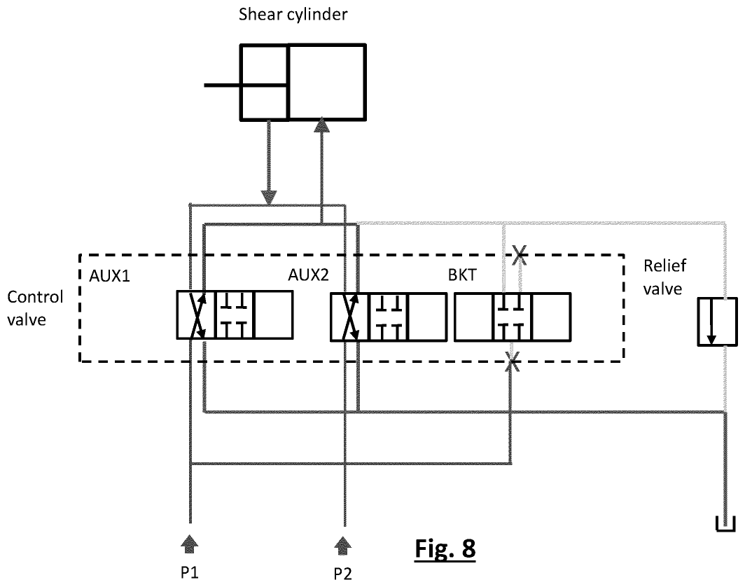

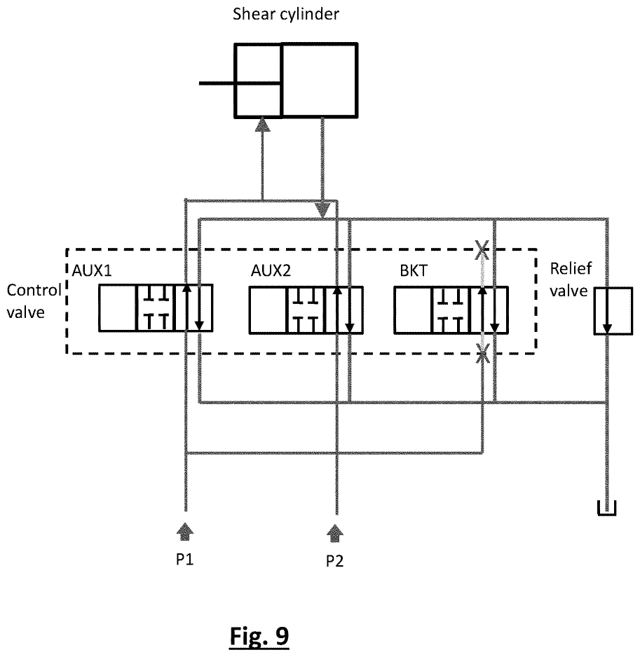

A 4 port, 3 position directional control valve may comprise an inlet port 11, 21 configured to receive hydraulic fluid from a hydraulic fluid pump, a return port (not shown in FIG. 1) configured to output hydraulic fluid to a hydraulic fluid reservoir, a first actuator outlet 13, 23 and a second outlet 14, 24. The first and second actuator outlets 13, 14, 23, 24 may be connected to either side of a cylinder of an actuator 30, for example, in order to drive the actuator 30. The 3 positions of the directional control valve 10, 20 may include a closed position, in which all ports are blocked. A first operating position may allow hydraulic fluid to flow between the inlet port 11 and the first actuator outlet, and to allow hydraulic fluid to flow between the second actuator outlet and the return port. A second operating position may allow hydraulic fluid to flow between the inlet port and the second actuator outlet, and to allow hydraulic fluid to flow between the first actuator outlet and the return port. A schematic diagram of such a directional control valve is shown in FIGS. 8 and 9 of the disclosure, discussed in more detail below.

The directional control valves 10, 20 of this disclosure may be controlled by a pilot pressure, or directly controlled by e.g. a solenoid, or any other suitable form of electromechanical interface between the controller and the directional control valves 10, 20 known to the skilled person.

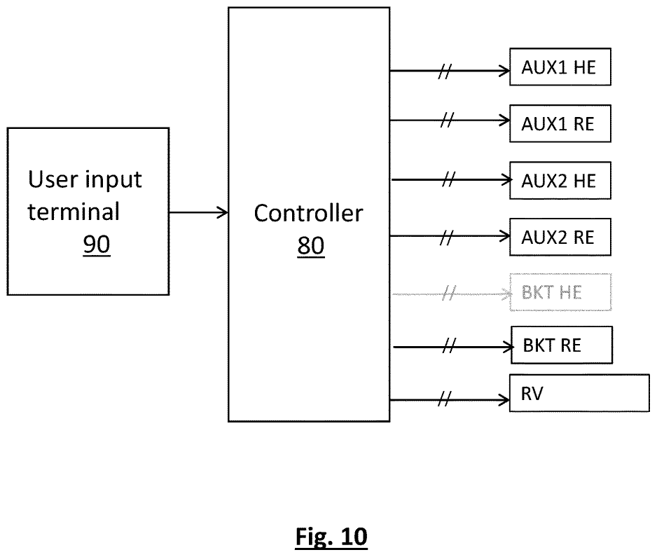

In some embodiments, each direction control valve 10, 20, 30 may be controlled by a pair of solenoids in combination with bias springs. The bias springs are configured to hold each direction control valve in the closed position when each solenoid is not active. A first solenoid (HE) may be configured to move the direction control valve such that the inlet port 11, 21 is connected to the first actuator outlet 13, 23. A second solenoid may be configured to move the direction control valve such that inlet port is connected to the second actuator outlet 14, 24. Each solenoid may be controlled by a suitable signal from the controller 80 (see FIG. 10 described further below).

While the embodiment of FIG. 1 utilises a 4 port, 3 position directional control valve, it will be appreciated that other forms of directional control valves which are suitable for controlling the flow of hydraulic fluid to and/or from the actuator 30 may be utilised in embodiments of the disclosure.

The second directional control valve 20 shown in FIG. 1 may be provided in a similar manner to the first directional control valve 10. As such, actuator 30 may be supplied with hydraulic fluid from both the first directional control valve 10 and the second directional control valve 20.

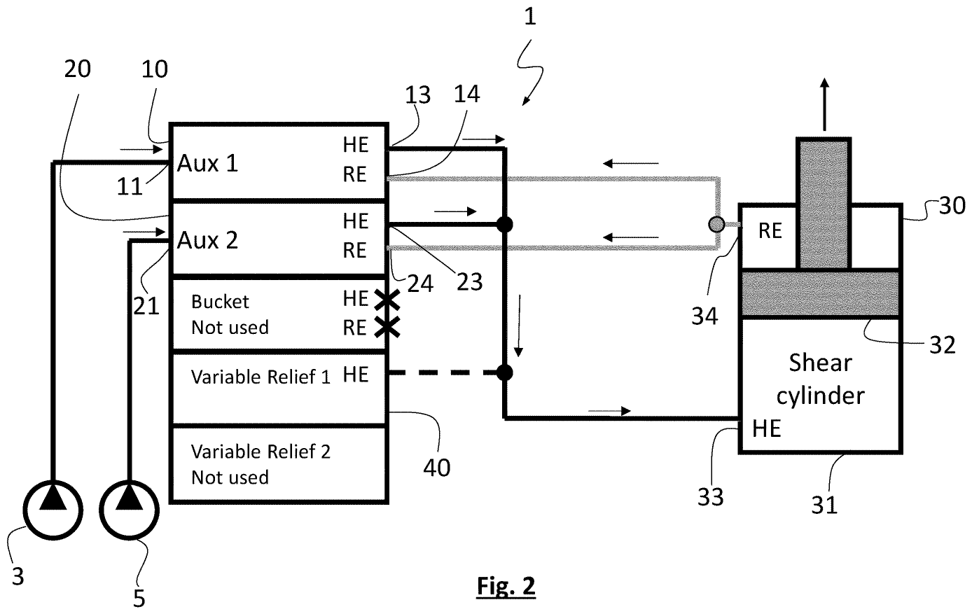

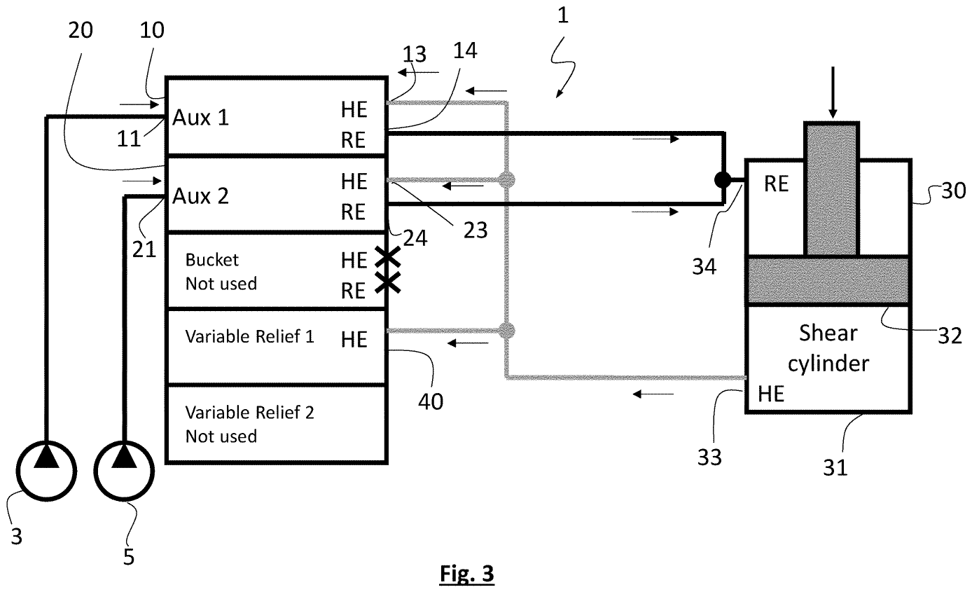

Relief valve 40 is configured to control the flow of hydraulic fluid from the actuator 30 to the
hydraulic fluid reservoir. The relief valve 40 may be connected to the hydraulic fluid reservoir and configured to receive hydraulic fluid from the actuator 30. In the embodiment of FIG. 1, the relief valve 40 is connected between the hydraulic fluid reservoir and the first port 33 of the actuator. As such, when the actuator is moving from the first position to the second position, (e.g. see FIG. 2) the relief valve 40 is connected to the high-pressure side of the actuator 30, wherein the relief valve 40 is configured to be closed. When the actuator is moving from the second position to the first position, the relief valve 40 is connected to the lower pressure, return, side of the actuator (e.g. see FIG. 3).

In some embodiments, the relief valve 40 may be configured to provide a pressure relief function. In some embodiments, the pressure release function may be controlled by the controller. As such, the relief valve 40 may be controlled by the controller to provide pressure relief above a pressure threshold. In some embodiments, the pressure relief threshold may be set by the controller. The pressure threshold may a value of no greater than 40 MPa for example. In some embodiments, the pressure relief valve 40 may be operated in a pressure relief mode (i.e. where the pressure relief threshold is active) or an open mode where the relief valve 40 is open (i.e. the pressure relief threshold is effectively 0 MPa).

Actuator 30 may be any actuator 30 suitable for use with a hydraulic system 1.

Actuator 30 shown in FIG. 1 may be a hydraulic linear actuator. Actuator 30 may be provided as part of a work machine. In particular, actuator 30 may be configured to provide mechanical power to a work tool of a work machine. In particular, the work tool may be a shear (not shown in FIG. 1), or other work tool where the majority of the mechanical work performed by the work tool over the operating cycle is due to the actuator moving from the first position to the second position. As such, when moving from the second position to the first position, very little, if any, effective work is performed by the work tool. Thus, it may be desirable for the actuator to move relatively quickly from the second position to the first position in order to reduce the operating cycle time of the actuator/work tool. By way of example, the following description will refer to a work tool such as a shear, wherein when the actuator 30 is in the first position the shear is an open position. When the actuator 30 is in a second position, the shear is in a closed position. It will be appreciated that embodiments of the disclosure are applicable to work tools, including work tools having an open position and a closed position.

In the embodiment of FIG. 1, a cylinder 31 of actuator 30 is shown schematically. A piston 32 is located in the cylinder 31. The cylinder 31 comprises a first port (HE port) 33 and a second port (RE port) 34 located on opposite sides of the piston 32. The first and second ports 33, 34 may be connected to the first and second actuator outlets respectively. Thus, the piston 32 (and thus actuator 30) may be driven between a first position (i.e. an open position of the shear) and a second position (i.e. a closed position of the shear) by controlling the flow of hydraulic fluid to the first and second ports 33, 34 of the actuator 30.

For example, FIG. 2 shows the hydraulic system 1 in a configuration where the actuator 30 is moving from a first position (an open position of the shear) to a second position (a closed position of the work tool). As shown in FIG. 2, the first and second direction control valves 10, 20 are each configured to allow hydraulic fluid to flow from the first and second hydraulic fluid pumps 3, 5 to the first port 33 of the actuator, causing the piston 32 of the actuator to move towards the second position. Hydraulic fluid also flows out of the second port 34 of the cylinder 31 to the second outlets 14, 24 of the first and second direction control valves 10, 20, and on to the hydraulic fluid reservoir.

As shown in the FIG. 2, relief valve 40 is provided on the high-pressure side of the hydraulic system when the actuator moves from the first position to the second position. As such, where the relief valve 40, no hydraulic fluid may flow through the relief valve 40 during normal operation of the hydraulic system. Where the relief valve 40 is configured to provide a pressure relief function, the relief valve 40 may prevent an overpressure from occurring in the hydraulic system 1 (i.e. the relief valve 40 will prevent the pressure on the high-pressure side of the hydraulic circuit from exceeding the pressure threshold). As such, for the configuration of the hydraulic system 1 shown in FIG. 2, it will be appreciated that the return path for hydraulic fluid to the hydraulic fluid reservoir in normal use (i.e. no overpressure) is provided by the first and second directional control valves 10, 20 only.

FIG. 3 shows the hydraulic system 1 in a configuration where the actuator 30 is moving from a first position (an open position of the work tool) to a second position (a closed position of the work tool).

As shown in FIG. 3, the first and second direction control valves 10, 20 are each configured to allow hydraulic fluid to flow from the first and second hydraulic fluid pumps 3, 5 to the second port 34 of the actuator 30, causing the piston 32 of the actuator 30 to move towards the first position. Hydraulic fluid also flows out of the first port 33 of the cylinder 31 to the first outlets 13, 23 of the first and second direction control valves 10, 20, and on to the hydraulic fluid reservoir. Hydraulic fluid also flows out of the first port 33 and to the hydraulic fluid reservoir via the relief valve 40, as the controller directs the relief valve 40 to allow the flow of hydraulic fluid to the hydraulic fluid reservoir. For example, the controller may set the pressure threshold to be about 0 MPa to allow hydraulic fluid to flow thought the relief valve 40 without any intentional obstruction. As such, by opening the relief valve 40, the hydraulic system 1 increases the capacity for hydraulic fluid flow on the low pressure, return side of the actuator 30 (relative to the configuration of FIG. 2). In embodiments, where the actuator is not performing a substantial amount of work when moving from the second position to the first position, such as where the actuator is opening a shear or similar work tool, the movement speed is often limited by the flow rate of hydraulic fluid leaving the cylinder 31. Thus, by increasing the available paths on the return side of hydraulic system when moving from the second position to the first position, the rate of hydraulic fluid flow may be increased, thereby allowing for quicker movement.

For example, in some embodiments, the controller is configured to control the hydraulic system such that the actuator moves from the second position to the first position in a duration of no greater than: 30 seconds, 25 second, 20 seconds, 15 seconds or 10 seconds. In the embodiment of FIG. 1, where the actuator 30 drives a shear, the controller may control the hydraulic system such that the actuator 30 for the shear moves from the first position (open) to the second position (closed) in about 12-14 seconds. Moving from the second position (closed) to the first position (open), where the relief valve 40 is open, may take about 8-9 seconds. Thus, in some embodiments, use of a relief valve 40 to increase flow capacity on the return circuit may reduce the time for the actuator to move from the second position to the first position by about 30% to 40%, relative to the time taken to move from the first position to the second position.

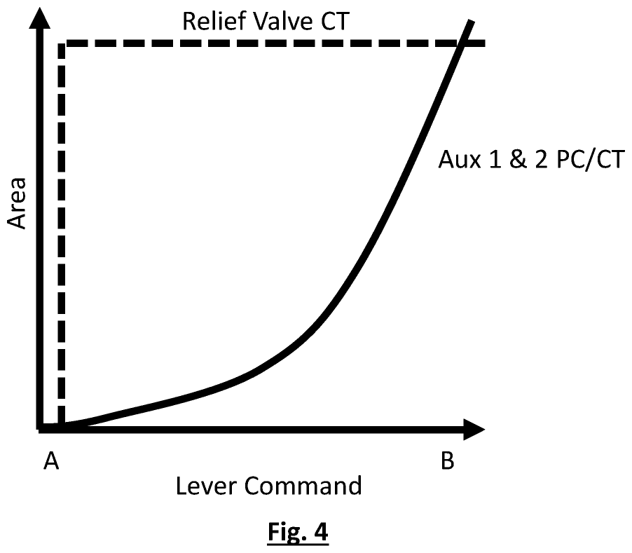

In some embodiments, the controller may be configured to move the first and second directional control valves 10, 20 and the relief valve 40 at different rates in order to control the movement of the actuator 30. For example, in some embodiments where the controller receives a command to move the actuator from the second position to the first position (e.g. a level command), the controller may open the first and second directional control valves 10, 20 gradually as the actuator moves from the first position to the second position. For example, the controller may control the first and second direction control valves 10, 20, such that an open area of each of the direction control valves 10, 20 increases with the movement of the actuator 30. Such control of an actuator 30 is well known to the skilled person. By contrast, the controller may be configured to control the relief valve to be fully open at the start of the movement from the second position to the first position. By way of example, FIG. 4 shows a graph of the variation in open valve area for each of the first and second control valves (Aux 1, Aux 2) in response to a lever command to move the actuator from point A (second position) to point B (first position). FIG. 4 also shows a graph of the open valve area for the relief valve in response to the lever command as the actuator 30 moves from the second position to the first position.

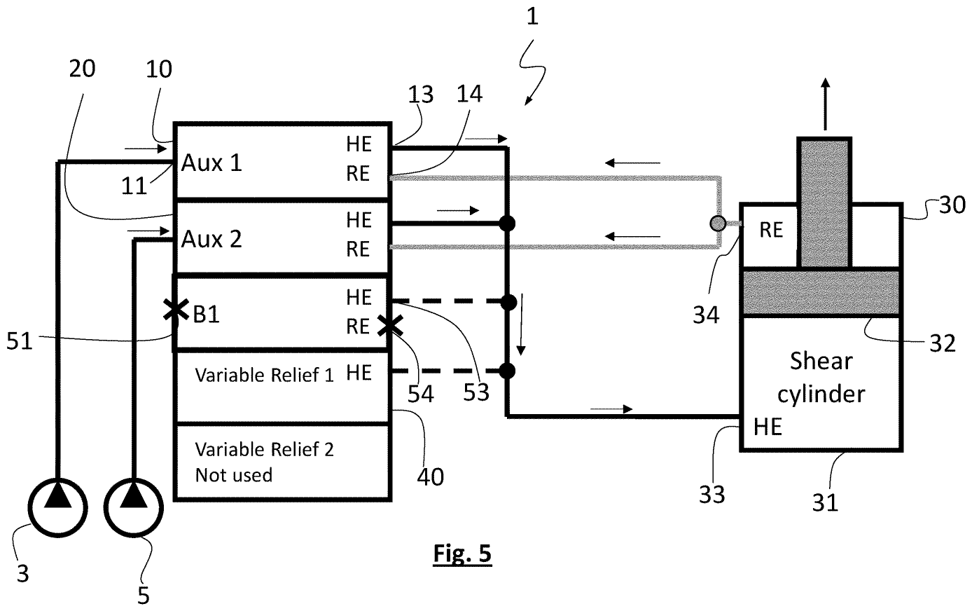

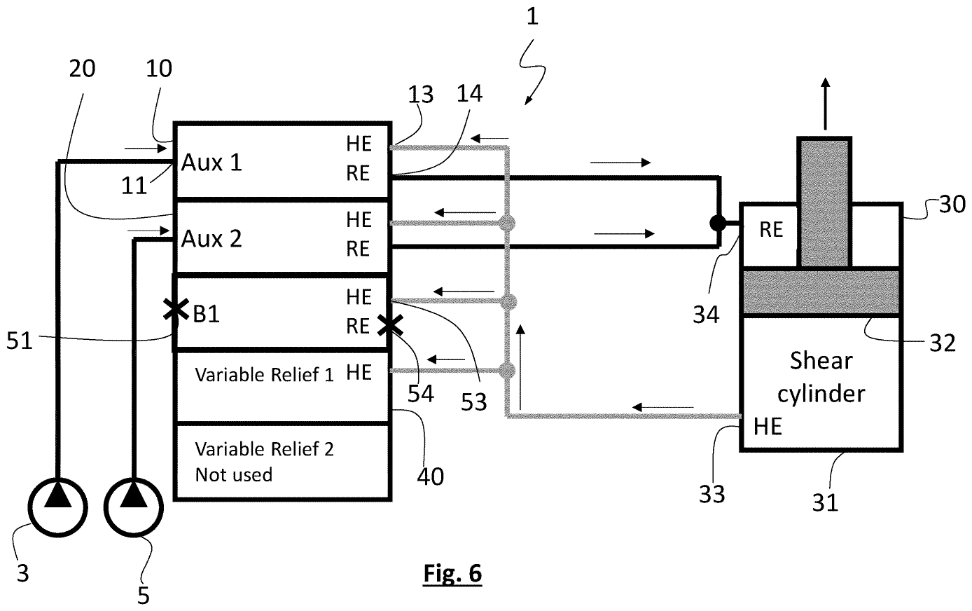

In some embodiments of the disclosure, it may be desirable to increase the flow capacity on the return circuit further. In such embodiments, one or more additional directional control valves may be utilised to provide additional capacity on the return circuit. Thus, in some embodiments, the hydraulic system 1 may further comprise a third direction control valve 50 configured to control the flow of hydraulic fluid to and from the actuator 30. The third direction control valve may be a 4 port, 3 position direction control valve similar to the first and second direction control valves 10, 20. FIGS. 5 and 6 shows a schematic diagram of a hydraulic system incorporating a third direction control valve 50.

In the embodiment of FIGS. 5 and 6, the third directional control valve 50 may be provided by another directional control valve 50 which is not currently being used on the work machine for the given work tool. For example, in the embodiment of FIGS. 5 and 6, the bucket directional control valve B1 may not be utilised to operate a shear. As shown in FIG. 5, a hydraulic fluid pump is not connected to the inlet port 51 of the third directional control valve 50 (i.e. the inlet port 51 is blocked). The second actuator outlet 54 is also not connected (i.e. blocked) to the hydraulic system. The first outlet port 53 is connected to the first outlet 33 of the actuator, similar to the first outlet ports 13, 23 of the other directional control valves 10, 20. The return port (not shown) may be connected to the hydraulic fluid reservoir. Thus, the third direction control valve 50 may be controlled in a similar manner to the first and second direction control valves 10, 20.

For example as shown in FIG. 5, when the actuator 30 moves from the first position to the second position, no hydraulic fluid flow through the third direction control valve 50 (similar to relief valve 40). When the actuator 30 moves from the second position to the first position, as shown in FIG. 6, hydraulic fluid flows through the third direction control valve 50 to the hydraulic fluid reservoir. As such, the third direction control valve 50 provides an additional flow path for hydraulic fluid on the return path when the actuator 30 moves from the second position to the first position. Thus, the hydraulic system may further reduce the cycle time of a work tool by providing opening additional return paths at times when the actuator 30 is not performing a significant amount of work.

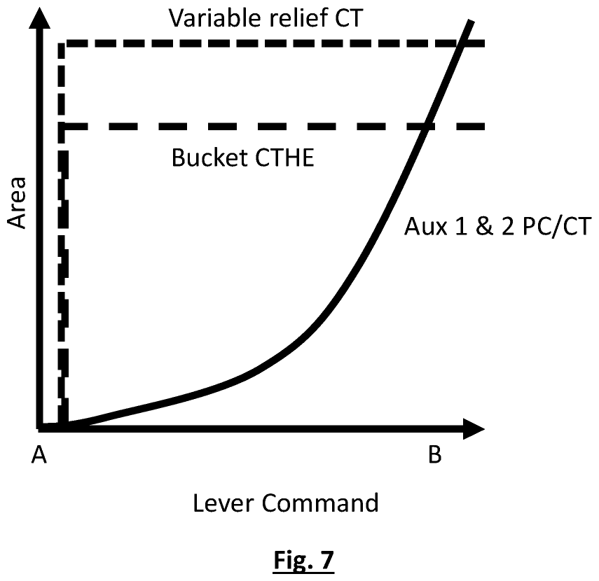

FIG. 7 shows a graph of the variation in open valve area for each of the first and second control valves (Aux 1, Aux 2) in response to a lever command to move the actuator from point A (second position) to point B (first position), similar to that of FIG. 4. FIG. 7 also shows a graph of the variation in the open valve area for the third direction control valve 50 (Bucket CTHE). It will be appreciated from the description of FIG. 4 that the third direction control valve 50 is controlled in a similar manner to the relief valve 40, wherein the valve is fully opened at the start of the movement from the second position to the first position.

FIGS. 8 and 9 show diagrams of the hydraulic circuit shown in the schematic diagrams of FIGS. 5 and 6. FIGS. 8 and 9 show the return path from return port 12, 24 of the first and second direction control valves 10, 20 to the hydraulic fluid reservoir 90.

As discussed above, the hydraulic system 1 of this disclosure may be controlled by a controller 80. FIG. 10 shows a block diagram of a controller 80 according to this disclosure. The controller 80 of FIG. 10 may be configured to receive a first signal from a user input terminal 90 to cause the controller 80 to cause the actuator 30 of the hydraulic system 1 to move from the first position to the second position. In some embodiments, the controller 80 may also receive a second signal from the user input terminal 90 to cause the controller 80 to cause the actuator 30 of the hydraulic system 1 to move from the second position to the first position. As shown in FIG. 10, the controller 80 may be configured to output control signals to first and second solenoids (HE, RE) of the first, second, and third direction control valves 10, 20, 30 (AUX1, AUX2, BKT). The controller 80 may also be configured to output a signal to a solenoid configured to control relieve valve 40 (RV). Thus, controller 80 may be configured to control the hydraulic system 1 described above.

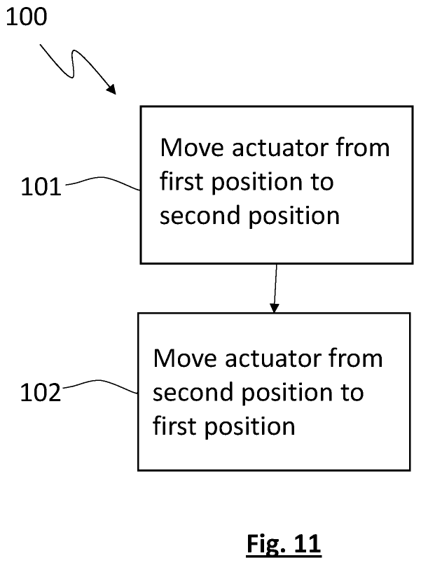

According to another embodiment, a method 100 of controlling a hydraulic system 1 for a work tool is provided. FIG. 11 shows a block diagram of the method 100. The method 100 may be performed by the controller 80 discussed above when configured to control the hydraulic system 1 of FIG. 1.

In a first step 101 of the method, an actuator of the work tool to moves from a first position to a second position. To provide the movement, a first directional control valve 10 and a second directional control valve 20 of the hydraulic system 1 open such that hydraulic fluid is pumped from a hydraulic fluid pump 3, 5 to the actuator 30 to cause the actuator 30 to move to the second position. Also, a relief valve 40 of the hydraulic system 1 is closed such that hydraulic fluid does not flow through the relief valve 40.

In a second step 102, the actuator 30 moves from the second position to the first position. To provide the movement, the first and second directional control valves 10, 20 open such that hydraulic fluid is pumped to the actuator 30 to cause the actuator to move to the first position. Also, the relief valve 40 opens to allow hydraulic fluid to return from the actuator 30 to a hydraulic fluid reservoir.

### INDUSTRIAL APPLICABILITY

According to this disclosure, a controller, a hydraulic system, and a method of controlling a hydraulic system are provided. The hydraulic system may be configured to provide mechanical power to an actuator of a work tool. In particular, the work tool may be a shear. In some embodiments, the hydraulic system and work tool may be provided as part of a work machine, for example an excavator. As such, the shear may be mounted on a boom arm of an excavator. As such, embodiments of this disclosure may be implemented on the hydraulic system of an excavator.

Embodiments of this disclosure may be particularly applicable to work tools having actuators with relatively large cylinder volumes. For example, in some embodiments, the actuator may have a cylinder volume of at least: 60 litres, 80 litres, 100 litres, 120 litres, or 140 litres. Where an actuator has a relatively large cylinder volume, attempting to move a relatively large volume of hydraulic fluid in a short duration of time can create a significant back pressure in the hydraulic system. The back pressure may effectively delay the movement of the actuator, thereby increasing the cycle time for the actuator. It will also be appreciated that the back pressure caused by the flow of hydraulic fluid causes the hydraulic pump to work harder than would otherwise be required. For example, where a typical back pressure for a hydraulic system of an excavator operating a shear may without a relief valve open may be about 14 MPa. By opening a relief valve according to an embodiment of the disclosure (e.g. FIGS. 2-3), the back pressure may be reduced to about 7 MPa. By also opening an additional direction control valve (e.g. FIGS. 5-6), the back pressure may be reduced to about 3 MPa. As such, embodiments of this disclosure may reduce the back pressure of the hydraulic system by about at least 50% or 75%.

By opening an additional flow path for hydraulic fluid, the controller of the first aspect effectively reduces the back pressure in the hydraulic system, thereby allowing the actuator to return to the first position more quickly and with lower power consumption. Thus, the controller of the first aspect may improve an operating cycle of the work tool and may also improve a fuel efficiency associated with the work tool.

In some embodiments, the work tool to be controlled may be a shear, or other work tool where the majority of the mechanical work performed by the work tool over the operating cycle is due to the actuator moving from the first position to the second position. As such, when moving from the second position to the first position, very little, if any, effective work is performed by the work tool. Thus, in some embodiments, the flow rate of hydraulic fluid through the hydraulic system may limit the rate at which the work tool can return to the first position for a new operating cycle. According to the first aspect, the controller may cause the hydraulic system to effectively increase the flow rate of hydraulic fluid on the return path to allow the actuator to return to the first position relatively quickly.

1. A controller configured to control an actuator of a hydraulic system for a work tool, wherein
the controller is configured to cause an actuator of the hydraulic system to move from a first position to a second position in which:
the controller causes a first directional control valve and a second directional control valve of the hydraulic system to open such that hydraulic fluid is pumped from a hydraulic fluid pump to the actuator to cause the actuator to move to the second position, and
the controller causes a relief valve of the hydraulic system to be closed such that hydraulic fluid does not flow through the relief valve; and
the controller is configured to cause the actuator to move from the second position to the first position in which:
the controller causes the first and second directional control valves to open such that hydraulic fluid is pumped from the hydraulic fluid pump to the actuator to cause the actuator to move to the first position; and
the controller causes the relief valve to open to allow hydraulic fluid to return from the actuator to a hydraulic fluid reservoir.

2. A controller according to claim 1, wherein
the controller is configured to control the hydraulic system such that the actuator moves from the second position to the first position in a duration of no greater than 10 seconds.

3. A controller according to claim 1, wherein
the controller is configured to receive a first signal from a user input terminal to cause the controller to cause the actuator of the hydraulic system to move from the first position to the second position; and/or
the controller is configured to receive a second signal from a user input terminal to cause the controller to cause the actuator of the hydraulic system to move from the second position to the first position.

4. A controller according to claim 1, wherein
when the controller causes the actuator of the hydraulic system to move from the first position to the second position, the controller causes the relief valve to operate in a pressure relief mode, wherein the relief valve opens to relieve pressure above a pressure threshold defined by the controller.

5. A controller according to claim 4, wherein the pressure threshold is a pressure of at least 30 MPa or at least 40 MPa.

6. A controller according to claim 1, wherein
the controller is configured to cause a third directional control valve of the hydraulic system to be closed such that hydraulic fluid does not flow through the third directional control valve when the actuator moves from the first position to the second position; and
the controller is configured to cause the third directional control valve of the hydraulic system to open to allow hydraulic fluid to return to from the actuator to the hydraulic fluid reservoir when the actuator moves from the second position to the first position.

7. A hydraulic system for a work tool, the hydraulic system comprising:
an actuator for the work tool;
a first directional control valve configured to control the flow of hydraulic fluid to and from the actuator;
a second directional control valve configured to the flow of hydraulic fluid to and from the actuator;
a hydraulic pump configured to pump hydraulic fluid to the actuator via the first and second directional control valves;
a hydraulic fluid reservoir connected to the first and second directional control valves and configured to receive hydraulic fluid flowing from the actuator via the first and second directional control valves;
a relief valve configured to control the flow of hydraulic fluid from the actuator to the hydraulic fluid reservoir, the relief valve connected to the hydraulic fluid reservoir and configured to receive hydraulic fluid from the work tool; and
the controller of claim 1.

8. A hydraulic system for a work tool, the hydraulic system comprising:
an actuator for the work tool;
a first directional control valve configured to control the flow of hydraulic fluid to and from the actuator;
a second directional control valve configured to the flow of hydraulic fluid to and from the actuator;
a third direction control valve configured to control the flow of hydraulic fluid to and from the actuator;
a hydraulic pump configured to pump hydraulic fluid to the actuator via the first and second directional control valves;
a hydraulic fluid reservoir connected to the first, second, and third directional control valves and configured to receive hydraulic fluid flowing from the actuator via the first, second, and third directional control valves;
a relief valve configured to control the flow of hydraulic fluid from the actuator to the hydraulic fluid reservoir, the relief valve connected to the hydraulic fluid reservoir and configured to receive hydraulic fluid from the work tool; and
the controller of claim 6.

9. A hydraulic system according to claim 7, wherein
one or more of the first, second, and third directional control valves are 4 port, 3 position directional control valves.

10. A hydraulic system according to claim 7, wherein
the work tool is a shear, wherein in the first position the shear is open and in the second position the shear is closed.

11. A hydraulic system according to claim 7, wherein
the actuator comprises a cylinder configured to receive hydraulic fluid, wherein the cylinder has a volume of at least 60 litres.

12. A hydraulic system according to claim 7, further comprising:
an additional hydraulic fluid pump,
wherein the hydraulic fluid pump is configured to pump hydraulic fluid to the actuator via the first directional control valve and the additional hydraulic fluid pump is configured to pump hydraulic fluid to the actuator via the second directional control valve.

13. A hydraulic system according to claim 7, wherein
when the controller causes the actuator of the hydraulic system to move from the first position to the second position,
the relief valve is configured to operate in a pressure relief mode controller where the relief valve opens to relieve pressure above a pressure threshold defined by the controller.

14. A hydraulic system according to claim 13, wherein
the pressure threshold is a pressure of at least 30 MPa or at least 40 MPa.

15. A method of controlling a hydraulic system for a work tool, comprising
causing an actuator of the work tool to move from a first position to a second position in which:
a first directional control valve and a second directional control valve of the hydraulic system to open such that hydraulic fluid is pumped from a hydraulic fluid pump to the actuator to cause the actuator to move to the second position, and
a relief valve of the hydraulic system to be closed such that hydraulic fluid does not flow through the relief valve; and
causing the actuator to move from the second position to the first position in which:
the first and second directional control valves open such that hydraulic fluid is pumped to the actuator to cause the actuator to move to the first position; and
the relief valve opens to allow hydraulic fluid to return from the actuator to a hydraulic fluid reservoir.

16. A method according to claim 15, wherein
the actuator moves from the second position to the first position in a duration of no greater than 10 seconds.

17. A method according to claim 15, wherein
a third directional control valve of the hydraulic system is closed such that hydraulic fluid does not flow through the third directional control valve when the actuator moves from the first position to the second position; and
the third directional control valve of the hydraulic system opens to allow hydraulic fluid to return to from the actuator to the hydraulic fluid reservoir when the actuator moves from the second position to the first position.

18. A method according to claim 15, wherein
when the actuator of the hydraulic system to moves from the first position to the second position, the relief valve operates in a pressure relief mode, wherein the relief valve opens to relieve pressure above a pressure threshold defined by the controller.

19. A method according to claim 18, wherein
the pressure threshold is a pressure of at least 30 MPa or at least 40 MPa.
